(19) United States
(12) Patent Application Publication
(10) Pub. No.: US 2022/0226192 A1
(43) Pub. Date: Jul. 21, 2022

(54) FLUID TRANSFER APPARATUS AND USE THEREOF

(71) Applicants: 4C DESIGN LIMITED, Glasgow Strathclyde (GB); MEAT & LIVESTOCK AUSTRALIA LIMITED, North Sydney, New South Wales (AU)

(72) Inventors: Douglas DEANS, Milngavie Strathclyde (GB); Robin SMITH, Glasgow Strathclyde (GB)

(73) Assignees: 4C DESIGN LIMITED, Glasgow Strathclyde (GB); MEAT & LIVESTOCK AUSTRALIA LIMITED, North Sydney, New South Wales (AU)

(21) Appl. No.: 17/606,555

(22) PCT Filed: Apr. 24, 2020
(86) PCT No.: PCT/GB2020/051013

§ 371 Date: Oct. 26, 2021

(30) Foreign Application Priority Data
Apr. 26, 2019 (GB) 1905866.8

(51) Int. Cl. A61J 1/20

(52) U.S. Cl. CPC A61J 1/201; A61J 1/2037; A61J 1/2089; A61J 1/2055; A61J 1/2051

(57) ABSTRACT

A fluid transfer apparatus is illustrated and described. The fluid transfer apparatus includes a fluid inlet, a fluid outlet and a fluid transfer device. The fluid inlet is associated with a fluid receptacle receiving portion, and the fluid receptacle receiving portion is configured to receive and engage at least a portion of a fluid receptacle. The fluid transfer apparatus is configurable between a first isolation state, in which the fluid transfer device is isolated from the fluid receptacle, such that the fluid container is fluidically isolated from the fluid inlet, to a second coupled state, in which the fluid transfer device is engaged with the fluid receptacle, such that the fluid receptacle is in fluid communication with the fluid inlet.

### FIELD OF THE INVENTION

The present invention relates particularly, but not exclusively, to a fluid transfer apparatus, a fluid transfer system, and methods of transferring fluid. The present invention also relates to use of a fluid transfer apparatus.

### BACKGROUND TO THE INVENTION

Known fluid transfer apparatuses are often used to transfer fluid from a fluid receptacle to a further fluid transfer apparatus or device. The fluid receptacle or container is typically opened, or punctured, prior to connection to the fluid transfer apparatus.

When applying fluid to an animal body part in an agricultural setting, and when applying fluids to a person in a medical setting, it can be cumbersome and time-consuming for the operator of a fluid transfer device to open the fluid receptacle and then to connect, or engage, the fluid receptacle with the fluid transfer device.

Furthermore, some known fluid transfer devices make use of an exposed spike located on the fluid transfer device, which allows the user to pierce the fluid receptacle by engaging the fluid receptacle with the spike. However, this can cause injury to the user, particularly when used in an outdoor setting or when the user attempts to connect a fluid receptacle to a fluid transfer device as quickly as possible.

Moreover, such known devices can be prone to cause leakage from the fluid receptacle, as the fluid receptacle is not secured to the fluid transfer apparatus prior to engaging the fluid receptacle with the spike (or other means of opening the fluid receptacle).

Therefore, it would be desirable to provide a fluid transfer apparatus that could be used to open the fluid receptacle in a reliable, safe and efficient manner.

The inventors have appreciated the shortcomings in known fluid transfer apparatuses.

According to a first aspect of the present invention there is provided a fluid transfer apparatus comprising:
a fluid inlet;
a fluid outlet; and
a fluid transfer device;
   wherein the fluid inlet is associated with a fluid receptacle receiving portion, the fluid receptacle receiving portion being configured to receive and engage at least a portion of a fluid receptacle, and
   wherein, in use, the fluid transfer apparatus is configurable between a first isolation state, in which the fluid transfer device is isolated from the fluid receptacle, such that the fluid container is fluidically isolated from the fluid inlet, to a second coupled state, in which the fluid transfer device is engaged with the fluid receptacle, such that the fluid receptacle is in fluid communication with the fluid inlet.

The fluid transfer apparatus is configured such that a fluid flow path exists from the fluid inlet, to the fluid transfer device, to the fluid outlet, such that, in use and in the second coupled state, fluid can flow from the fluid receptacle to the fluid outlet via the fluid flow path.

The fluid transfer apparatus may comprise one or more fluid inlets. The fluid transfer apparatus may comprise one or more fluid outlets.

The fluid transfer apparatus may be operable to lock the fluid transfer device in the second coupled state. The fluid transfer apparatus may be irreversibly configurable in the second coupled state. The fluid transfer apparatus may be configured such that the fluid transfer device may not be unlocked from the second coupled state. The fluid transfer apparatus may be configurable from the first isolation state to the second coupled state and prevented from returning to the first isolation state.

The fluid transfer apparatus may be operable to move the fluid transfer device between a first and second position when the fluid transfer apparatus is configured between the first isolation state and the second coupled state. The fluid transfer apparatus may be operable to irreversibly move the fluid transfer device from the first position to the second position. The fluid transfer apparatus may be operable to lock the fluid transfer device at the second position.

The fluid transfer apparatus may be operable to open, pierce, puncture, penetrate, perforate, cut, slit, prick, spike, broach, breach, rupture, split, and/or fracture at least a portion of the fluid receptacle. In this arrangement, the fluid transfer apparatus is operable to allow fluid to flow from the fluid receptacle.

The fluid transfer apparatus may be configurable between a locked and unlocked state. In the locked state, the fluid transfer apparatus is prevented from being configurable between the first isolation state and the second coupled state. In the unlocked state, the fluid transfer apparatus is configurable between the first isolation state and the second coupled state.

The fluid receptacle receiving portion may be configured to secure, connect, fix, and/or clamp at least a portion of the fluid receptacle thereto. The fluid receptacle receiving portion may be configured to irreversibly secure, irreversibly connect, irreversibly fix, and/or irreversibly clamp at least a portion of the fluid receptacle thereto. The fluid receptacle receiving portion may be configured to lock at least a portion of the fluid receptacle with the fluid receptacle receiving portion. The fluid receptacle receiving portion may be configured to irreversibly lock at least a portion of the fluid receptacle with the fluid receptacle receiving portion. The fluid receptacle receiving portion may be configured to prevent removal of at least a part of the fluid receptacle from the fluid receptacle receiving portion when the at least a portion of the fluid receptacle is locked with the fluid receptacle receiving portion.

The fluid transfer apparatus may be configured to shield, protect, cover, enclose, substantially surround, accommodate, and/or house at least a portion of the fluid transfer device. The fluid transfer apparatus may be configured to shield, protect, cover, accommodate, and/or house at least a portion of the fluid transfer device in the first isolation state and/or in the second isolation state.

The fluid transfer apparatus may be configured to provide support to the fluid receptacle when at least a portion of the fluid receptacle is received and engaged by the fluid receptacle receiving portion.

The fluid transfer apparatus may be configured to allow fluid to flow from the fluid inlet to the fluid outlet and to substantially prevent fluid flow from the fluid outlet to the fluid inlet. In the second coupled state, the fluid transfer apparatus may be configured to allow fluid to flow from the fluid inlet to the fluid outlet and to substantially prevent fluid flow from the fluid outlet to the fluid inlet. The fluid transfer apparatus may be configured to allow substantially unidirectional fluid flow from the fluid inlet to the fluid outlet. In the second coupled state the fluid transfer apparatus may be configured to allow substantially unidirectional fluid flow from the fluid inlet to the fluid outlet. The fluid transfer device may comprise one or more valves, unidirectional valves, one-way valves, or the like. The fluid transfer device may comprise one or more liquid-permeable valves. The fluid transfer device may be configured to accommodate one or more of the valves. The fluid transfer device may comprise one or more valve accommodating portions configured to receive the, or each, valve.

The fluid transfer device may be configured to bias the, or each, valve in the closed position. The fluid transfer device may comprise one or more biasing members arranged to bias the, or each, valve in the closed position. The, or each, biasing member may be a spring member. The spring member may be a compression spring and/or a helical spring, or the like. The, or each, biasing member may be a resilient member. The resilient member may be made from a plastics material or a rubber material.

The fluid transfer device may comprise a further fluid inlet. The fluid transfer apparatus may be configured to allow a first fluid to flow from the fluid inlet to the fluid outlet, and to allow a second fluid to flow from the further fluid inlet to the fluid inlet of the fluid transfer apparatus. The first fluid may be a liquid or a liquid/gas mixture. The second fluid may be a gas. In use, the fluid transfer apparatus may be configured to allow the second fluid to flow from the further fluid inlet to the fluid receptacle. The second fluid may be substantially air, or atmospheric air. The further fluid inlet may be liquid-impermeable. The further fluid inlet may be gas-permeable. The further fluid inlet may be liquid-impermeable and gas-permeable. The further fluid inlet may be configured to block the flow of liquid and to allow the flow of gas. The further fluid inlet may be configured to allow unidirectional fluid flow therethrough. The further fluid inlet may include a check valve, or the like. The further fluid inlet may comprise one or more hydrophobic valves, duckbill valves, umbrella valves, or the like. The filter element may be a hydrophobic filter, or the like.

The fluid transfer apparatus may be a substantially rigid member. The fluid transfer apparatus may be configured for use in an agricultural environment or setting.

The fluid transfer apparatus may comprise a housing configured to accommodate at least a portion of the fluid transfer device.

The housing may be configured to permit movement of the fluid transfer device between the first and second position when the fluid transfer apparatus is configured between the first isolation state and the second coupled state. The housing may be configured to permit movement of the fluid transfer device from the first position to the second position and to substantially prevent movement of the fluid transfer device from the second position to the first position. The housing may be configured to allow locking of the fluid transfer device at the second position.

The housing may comprise a first part and a second part. The housing may be configurable to permit relative movement of the first and second parts. The housing may be configurable to permit relative movement of the first and second parts along a longitudinal axis of the fluid transfer apparatus. In use, the housing may be configurable to permit the second part to move relative to the first part and relative to the fluid receptacle. In use, the second part may be fixed relative to the fluid receptacle.

The housing may be configured such that the first part is engageable with the second part. The housing may be configured such that the first part is releasably engageable with the second part. The housing may be configured such that the first part is connected to the second part.

The housing may be configurable between a first, locked state, in which the fluid transfer apparatus is prevented from being configured between the first isolation state and the second coupled state, and a second, unlocked state, in which the fluid transfer apparatus can be configured between the first isolation state and the second coupled state. In the second, unlocked state, the first part of the housing may be movable relative to the second part of the housing along the longitudinal axis of the fluid transfer apparatus. The first part and/or the second part of the housing may comprise one or more guide members configured to permit movement of the first part relative to the second part along the longitudinal axis of the fluid transfer apparatus. The guide members may be one or more ribs, bars, rails, or the like and one or more corresponding grooves, slots, holes, or the like.

The fluid transfer device and/or the second part of the housing may comprise one or more guide members configured to permit movement of the fluid transfer device relative to the second part of the housing. The guide members may be one or more ribs, bars, rails, or the like and one or more corresponding grooves, slots, holes, or the like.

The housing may be configured such that the first part is at least partially rotatable relative to the second part about an axis of rotation. The axis of rotation may be the longitudinal axis of the housing and/or the longitudinal axis of the fluid transfer apparatus. The housing may be configurable between the first, locked state and the second, unlocked state when the first part is at least partially rotated relative to the second part about the axis of rotation. The housing may be configured such that the first part is rotatable relative to the second part from a first point, in which the guide members of the first part and the second part are not substantially in alignment, to a second point, in which the guide members of the first part and the second part are substantially in alignment. The housing may be configured such that the first part is rotatable relative to the second part from a first point, in which the guide members of the fluid transfer device and the first part and/or the second part are not substantially in alignment, to a second point, in which the guide members of the fluid transfer device and the first part and/or the second part are substantially in alignment.

The housing may be configured such that the first part is rotatable relative to the second part from the first point to the second point, and such that the first part cannot be rotated from the second point back to the first point. In this arrangement, the first part is irreversibly rotatable from the first point to the second point.

The second part of the housing may comprise one or more first guide members and one or more second guide members. The second part of the housing may comprise a latch member. The latch member may be configured to allow the guide members of the fluid transfer device to move from the first guide members to the second guide members of the second part of the housing when the first part is rotated relative to the second part.

The first part of the housing may be connectable to the fluid transfer device. The first part of the housing may be connectable to an end portion, or end region, of the fluid transfer device. The first part of the housing may be fixed to the fluid transfer device.

The fluid transfer device may be locatable in at least part of the second part of the housing. The second part of the housing may be configured to receive at least a portion of the fluid transfer device. At least a portion of the second part of the housing may be configured to be in abutment with at least a portion of the fluid transfer device when the housing is in the first, locked state. The second part of the housing may be configured to permit movement of the fluid transfer device relative to the second part of the housing when the housing is in the second, unlocked state. The fluid transfer device may be locatable in at least part of the first part of the housing and in at least part of the second part of the housing.

The second part of the housing may be configured to secure at least a portion of the fluid transfer device therein when the fluid transfer apparatus is in the second coupled state. The second part of the housing may be configured to engage and lock the fluid transfer device therein when the fluid transfer apparatus is in the second coupled state. The second part of the housing may be configured to permanently secure the fluid transfer device to the second part of the housing when the fluid transfer apparatus is in the second coupled state. The second part of the housing may be configured to prevent removal of the fluid transfer device from the second part of the housing when the fluid transfer apparatus is in the second coupled state. The fluid transfer device may comprise one or more engagement members configured to engage with the first part of the housing, when the fluid transfer apparatus is in the first isolation state, the one or more engagement members being configured to engage with the second part of the housing when the fluid transfer apparatus is in the second coupled state. The fluid transfer device may comprise one or more engagement members configured to be located within the first part of the housing, when the fluid transfer apparatus is in the first isolation state, the one or more engagement members being configured to engage with the second part of the housing when the fluid transfer apparatus is in the second coupled state. The engagement members may be configured to engage with corresponding engagement members of the first and/or second part of the housing. The engagement members of the fluid transfer device may be one or more tabs, lips, flaps, protruding members, protrusions, or the like. The engagement members of the fluid transfer device and the corresponding engagement members of the second part of the housing may be configured to permanently secure the fluid transfer device at the second coupled state. The engagement members of the fluid transfer device and the corresponding engagement members of the second part of the housing may be configured to prevent removal of the fluid transfer device from the second coupled state. The engagement members may be substantially resilient members. The corresponding engagement members of the first part and/or second part of the housing may be slots, holes, apertures, grooves, channels, or the like, configured to receive the engagement members of the fluid transfer device.

The first part of the housing may be associated with the fluid outlet of the fluid transfer apparatus. The second part of the housing may be associated with the fluid inlet of the fluid transfer apparatus. The second part of the housing may include the fluid receptacle receiving portion.

The first part and the second part of the housing may be separately formed. The housing may be a substantially rigid member.

The fluid transfer device may include the fluid inlet. The fluid inlet of the fluid transfer apparatus may be defined by one or more openings, apertures, holes, and/or orifices, or the like, in the fluid transfer device. The fluid inlet may be located adjacent to an end region, end section or end portion of the fluid transfer device.

The fluid transfer device may be configured to open, pierce, puncture, penetrate, perforate, cut, slit, prick, spike, broach, breach, rupture, split, and/or fracture, at least a portion of the fluid receptacle. The fluid transfer device may be configured to open, pierce, puncture, penetrate, perforate, cut, slit, prick, spike, broach, breach, rupture, split, and/or fracture, at least a portion of the fluid receptacle when the fluid transfer apparatus is configured from the first isolation state to the second coupled state. At least a portion of the fluid receptacle may be frangible.

The fluid transfer device may comprise one or more engagement members for engaging the fluid receptacle. The engagement member may be a protruding member. The engagement member may comprise a spike member, a piercing member, a pin member, and/or a nail member, or the like. The one or more engagement members may be configured to open, pierce, puncture, penetrate, perforate, cut, slit, prick, spike, broach, breach, rupture, split, and/or fracture, at least a portion of the fluid receptacle when the fluid transfer apparatus is configured from the first isolation state to the second coupled state.

The engagement member may be configured such that it cannot be removed from the fluid receptacle when the engagement member is located in the fluid receptacle. The engagement member may be configured such that it cannot be removed from the fluid receptacle when the fluid transfer apparatus is configured in the second coupled state. The engagement member may comprise one or more locking members configured to prevent the engagement member being removed from the fluid receptacle when the engagement member is at least partially located in the fluid receptacle. The locking member(s) of the engagement member may be one or more barb members and/or hook members, or the like, configured to allow the engagement member to be located at least partially within the fluid receptacle and configured to prevent the engagement member from being removed from the fluid receptacle.

The engagement member may be configured to be at least partially frangible. At least a portion of the engagement member for engaging the fluid receptacle may comprise a frangible portion.

The engagement member may comprise one or more locking members configured to prevent removal of the engagement member from the fluid receptacle and the engagement member may be configured to be at least partially frangible. The engagement member may comprise one or more locking members configured to prevent removal of the engagement member from the fluid receptacle and the engagement member may be configured to be at least partially frangible, such that, the attempted removal of the engagement member from the fluid receptacle results in the engagement member being fractured or broken.

The fluid transfer apparatus may be configured to move the engagement member with respect to, or within, the fluid receptacle when the fluid receptacle is received and engaged by the fluid receptacle receiving portion. The fluid transfer apparatus may be configured to move the engagement member along the longitudinal axis of the fluid transfer apparatus. The fluid transfer apparatus may be configured to arrange the engagement member substantially along the longitudinal axis of the fluid transfer apparatus. The engagement member may be a substantially elongate member. The engagement member may be a substantially elongate member arranged along the longitudinal axis of the fluid transfer apparatus.

The engagement member may include a, or the fluid inlet. The fluid inlet of the fluid transfer apparatus may be located on the engagement member. A fluid inlet of the fluid transfer apparatus may be located on a wall portion of the engagement member. A fluid inlet of the fluid transfer apparatus may be located at an arcuate, or curved, wall portion of the engagement member. The engagement member may comprise a body portion. A fluid inlet may be located on the body portion of the engagement member.

The fluid transfer apparatus may comprise a fluid flow path from the fluid receptacle to the engagement member of the fluid transfer device to the fluid outlet.

A fluid inlet of the fluid transfer apparatus may be defined by one or more openings, apertures, holes, and/or orifices, or the like, in the engagement member.

The fluid transfer apparatus may be configured to allow movement of the, or each, engagement member into engagement with the fluid receptacle when the fluid transfer apparatus is configured from the first isolation state to the second coupled state. The fluid transfer apparatus may be configured to allow movement of the, or each, engagement member along the longitudinal axis of the fluid transfer apparatus into engagement with the fluid receptacle when the fluid transfer apparatus is configured from the first isolation state to the second coupled state.

The fluid transfer apparatus may be configured to prevent the engagement member from protruding beyond, or outside of, the housing. The fluid transfer apparatus may be configured to protect, or shield, the engagement member when the fluid transfer apparatus is configured in the first isolation state.

The fluid transfer device may be a substantially rigid member.

The fluid transfer apparatus may be configured such that, in the first isolated state, the fluid inlet is located distal to the fluid receptacle receiving portion, and in the second coupled state, the fluid inlet is located proximal to, or inside, the fluid receptacle receiving portion. The fluid transfer apparatus may be configured such that, in the first isolated state, the fluid inlet is located outside the fluid receptacle receiving portion, and in the second coupled state, the fluid inlet is located inside, the fluid receptacle receiving portion.

The fluid transfer apparatus may be configured such that the fluid inlet is locatable substantially inside the fluid receptacle. The fluid transfer apparatus may be configured such that, in the second coupled state, the fluid inlet is located substantially inside the fluid receptacle. The fluid transfer apparatus may be configured such that the fluid inlet is locatable substantially adjacent to a neck portion, a rim portion, an aperture, an opening, and/or an end region of the fluid receptacle. The fluid transfer apparatus may be configured such that, in the second coupled state, the fluid inlet is located substantially adjacent to a neck portion, a rim portion, an aperture, an opening, and/or an end region of the fluid receptacle.

The fluid outlet of the fluid transfer apparatus may be located at an end region of the fluid transfer apparatus. The fluid outlet of the fluid transfer apparatus may be located at an opposite region, or part, of the fluid transfer apparatus to the fluid inlet. The fluid outlet may be one or more openings, apertures, holes, and/or orifices, or the like. The fluid outlet may be located on the housing of the fluid transfer apparatus. The fluid outlet may be located on the first part of the housing.

The fluid receptacle receiving portion may comprise one or more engagement members configured to receive and engage with at least a portion of the fluid receptacle. The engagement members may be collar members, skirt members, lip members, and/or protruding members, configured to receive and engage with at least a portion of the fluid receptacle.

The fluid receptacle receiving portion may comprise one or more locking members configured to lock the fluid receptacle to the fluid receptacle receiving portion. The fluid receptacle receiving portion may be configured to engage with the fluid receptacle in an interference fit, a snap-fit, or the like. The locking members may be one or more hooks, barbs, and/or tab members, or the like. The one or more locking members may be at least partially resilient members. The one or more locking members may be configured to engage with at least a portion of the fluid receptacle in an interference fit. The locking member(s) may be arranged to engage with and abut a collar portion, or an underside thereof, of the fluid receptacle.

The fluid receptacle receiving portion may be configured to substantially prevent movement of the fluid receptacle relative to the fluid transfer apparatus when the fluid receptacle is received and engaged by the fluid receptacle receiving portion.

At least a part of the fluid receptacle receiving portion may be configured to support at least a part of the fluid receptacle. The fluid receptacle receiving portion may comprise one or more first support members configured to support one or more corresponding support members of the fluid receptacle. The support members of the fluid receptacle receiving portion may be rail members, ribs, elongate members, protrusions, protruding members, or the like.

The fluid transfer apparatus may be configured to align the fluid receptacle to the fluid transfer device. The fluid receptacle receiving portion may be configured to substantially align a longitudinal axis of the fluid receptacle and the longitudinal axis of the fluid transfer apparatus.

The fluid receptacle receiving portion may be a substantially rigid member. The fluid receptacle receiving portion may be a substantially rigid member and the locking member(s) of the fluid receptacle receiving portion may be at least partially resilient members.

The fluid receptacle receiving portion may comprise one or more second support members configured to, in use, provide support to the fluid receptacle. The support members may be one or more collar members, skirt members, lip members, and/or protruding members, or the like.

The first support members and/or the second support members may be correspondingly shaped to a shoulder portion, a neck portion and/or a head portion of the fluid receptacle.

The fluid receptacle receiving portion may have a substantially circular cross section along the longitudinal axis of the fluid transfer apparatus. The fluid receptacle receiving portion may be shaped to receive and support the shoulder portion, the neck portion and/or the head portion of the fluid receptacle. The fluid receptacle receiving portion may be configured to slidably engage with at least a part of the fluid receptacle. The fluid receptacle receiving portion may be configured to snugly fit with the shoulder portion, neck portion and/or head portion of the fluid receptacle. At least a part of the fluid receptacle receiving portion may be configured to be in contact with the shoulder portion, the neck portion and/or the head portion of the fluid receptacle when the fluid receptacle portion is received and engaged by the fluid receptacle receiving portion.

The fluid transfer apparatus may be configured such that, in the first isolation state, the fluid transfer device is remote from the fluid receptacle. The fluid transfer apparatus may be configured such that, in the first isolation state, the fluid transfer device is substantially separate from the fluid receptacle. The fluid transfer apparatus may be configured such that, in the first isolation state, the fluid transfer device is substantially distal from the fluid receptacle. The fluid transfer apparatus may be configured such that, in the first isolation state, the fluid transfer device is spaced from the fluid receptacle. The fluid transfer apparatus may be configured such that, in the first isolation state, the fluid transfer device is substantially not in contact from the fluid receptacle.

The housing may be configured such that, in the first isolation state, the housing can be configured between the locked state and the unlocked state.

In the first isolation state, the fluid receptacle can be engaged and received by the fluid receptacle receiving portion.

The fluid transfer apparatus may be connectable to a further fluid transfer apparatus. The further fluid transfer apparatus may be a substance applicator for applying a substance to a human or animal body part. The fluid outlet of the fluid transfer apparatus may engageable with a fluid inlet of the further fluid transfer apparatus. The fluid transfer apparatus may be configured such that, in use, fluid can flow from the fluid receptacle to the fluid inlet of the further fluid transfer apparatus when the fluid transfer apparatus is engaged with the further fluid transfer apparatus. The further fluid transfer apparatus may be a hand-held apparatus.

The fluid outlet of the fluid transfer apparatus may be configured to be engageable with the fluid inlet of the further fluid transfer apparatus. The fluid outlet of the fluid transfer apparatus may be configured to be engageable only with the fluid inlet of the further fluid transfer apparatus. The fluid inlet of the further fluid transfer apparatus may be configured to be engageable only with the fluid outlet of the fluid transfer apparatus. The fluid outlet of the fluid transfer apparatus and the fluid inlet of the further fluid transfer apparatus may be configured to only engage with each other. The fluid outlet of the fluid transfer apparatus may be configured to be permanently connected to the fluid transfer apparatus. The fluid inlet of the further fluid transfer apparatus may be configured to be permanently connect to the further fluid transfer apparatus. The fluid outlet of the fluid transfer apparatus may be configured such that it cannot engage with other device(s), and can only engage with the fluid inlet of the further fluid transfer apparatus. The fluid inlet of the further fluid transfer apparatus may be configured such that it cannot engage with other device(s), and can only engage with the fluid outlet of the fluid transfer apparatus.

The fluid transfer apparatus may include a connection means configured to connect with a corresponding connection means of the further fluid transfer apparatus. The connection means of the fluid transfer apparatus may be a male connector and the connection means of the further fluid transfer apparatus may be a female connector.

The connection means of the fluid transfer apparatus may include a seal member and/or a gasket member. The seal member may be a face seal, or the like. The gasket member may be an o-ring, or the like.

The connection means of the further fluid transfer apparatus may include a seal member and/or a gasket member. The seal member may be a face seal, or the like. The gasket member may be an o-ring, or the like.

The connection means of the fluid transfer apparatus may be a Luer lock, or the like. The connection means of the further fluid transfer apparatus may be a Luer lock, or the like. The connection means of the fluid transfer apparatus may be configured to only connect with the connection means of the further fluid transfer apparatus. The connection means of the further fluid transfer apparatus may be configured to only connect with the connection means of the fluid transfer apparatus. The connection means of the fluid transfer apparatus and the connection means of the further fluid transfer apparatus may be configured to only be connectable to each other. The connection means of the fluid transfer apparatus and the connection means of the further fluid transfer apparatus may be configured to only be connectable to each other, and not to other devices.

The further fluid transfer apparatus may comprise one or more fluid inlets, the, or each fluid inlet being engageable with a fluid outlet of a fluid transfer apparatus. In this arrangement, a plurality of fluid transfer apparatuses according to the first aspect of the present invention may be engaged with the further fluid transfer apparatus.

According to a second aspect of the present invention there is provided a fluid transfer system comprising:

a fluid transfer apparatus comprising:
a fluid inlet;
a fluid outlet; and
a fluid transfer device;
wherein the fluid inlet is associated with a fluid receptacle receiving portion, the fluid receptacle receiving portion being configured to receive and engage at least a portion of a fluid receptacle, and
wherein, in use, the fluid transfer apparatus is configurable between a first isolation state, in which the fluid transfer device is isolated from the fluid receptacle, such that the fluid container is fluidically isolated from the fluid inlet, to a second coupled state, in which the fluid transfer device is engaged with the fluid receptacle, such that the fluid receptacle is in fluid communication with the fluid inlet; and
   a further fluid transfer apparatus, the further fluid transfer apparatus comprising a fluid inlet;
   wherein the fluid outlet of the fluid transfer apparatus is engageable with the fluid inlet of the further fluid transfer apparatus.

The further fluid transfer apparatus may be a substance applicator for injecting and/or applying a substance to a human or animal body part.

The fluid transfer system may comprise a fluid receptacle.

Embodiments of the second aspect of the present invention may include one or more features of the first aspect of the present invention or its embodiments. Similarly, embodiments of the first aspect of the present invention may include one or more features of the second aspect of the present invention or its embodiments.

According to a third aspect of the present invention there is provided a method of transferring fluid, the method comprising the steps of: providing a fluid receptacle;

providing a fluid transfer apparatus comprising:
a fluid inlet;
a fluid outlet; and
a fluid transfer device;
   wherein the fluid inlet is associated with a fluid receptacle receiving portion, the fluid receptacle receiving portion being configured to receive and engage at least a portion of the fluid receptacle, and
   wherein, in use, the fluid transfer apparatus is configurable between a first isolation state, in which the fluid transfer device is isolated from the fluid receptacle, such that the fluid container is fluidically isolated from the fluid inlet, to a second coupled state, in which the fluid transfer device is engaged with the fluid receptacle, such that the fluid receptacle is in fluid communication with the fluid inlet;
   using the fluid receptacle receiving portion to receive and engage at least a portion of the fluid receptacle; and
   transferring fluid from the fluid receptacle to the fluid outlet by configuring the fluid transfer apparatus from the first isolation state to the second coupled state.

The method may comprise the step of operating the fluid transfer apparatus to lock the fluid transfer device in the second coupled state. The method may comprise the step of irreversibly configuring the fluid transfer apparatus in the second coupled state. The method may comprise the step of configuring the fluid transfer apparatus such that the fluid transfer device may not be unlocked from the second coupled state. The method may comprise the step of configuring the fluid transfer apparatus from the first isolation state to the second coupled state and preventing the fluid transfer apparatus from returning to the first isolation state.

The method may comprise the step of operating the fluid transfer apparatus to move the fluid transfer device between a first and second position when the fluid transfer apparatus is configured between the first isolation state and the second coupled state. The method may comprise the step of operating the fluid transfer apparatus to irreversibly move the fluid transfer device from the first position to the second position. The method may comprise the step of operating the fluid transfer apparatus to lock the fluid transfer device at the second position.

The method may comprise the step of operating the fluid transfer apparatus to open, pierce, puncture, penetrate, perforate, cut, slit, prick, spike, broach, breach, rupture, split, and/or fracture at least a portion of the fluid receptacle. In this arrangement, the fluid transfer apparatus is operable to allow fluid to flow from the fluid receptacle.

The method may comprise the step of configuring the fluid transfer apparatus between a locked and unlocked state. In the locked state, the fluid transfer apparatus is prevented from being configurable between the first isolation state and the second coupled state. In the unlocked state, the fluid transfer apparatus is configurable between the first isolation state and the second coupled state.

The method may comprise the step of using the fluid receptacle receiving portion to secure, connect, fix, and/or clamp at least a portion of the fluid receptacle thereto. The method may comprise the step of using the fluid receptacle receiving portion to irreversibly secure, irreversibly connect, irreversibly fix, and/or irreversibly clamp at least a portion of the fluid receptacle thereto. The method may comprise the step of using the fluid receptacle receiving portion to lock at least a portion of the fluid receptacle with the fluid receptacle receiving portion. The method may comprise the step of using the fluid receptacle receiving portion to irreversibly lock at least a portion of the fluid receptacle with the fluid receptacle receiving portion. The method may comprise the step of using the fluid receptacle receiving portion to prevent removal of at least a part of the fluid receptacle from the fluid receptacle receiving portion when the at least a portion of the fluid receptacle is locked with the fluid receptacle receiving portion.

The method may comprise the step of engaging the first part of the housing with the second part of the housing. The method may comprise the step of releasably engaging the first part of the housing with the second part of the housing. The method may comprise the step of connecting the first part of the housing to the second part of the housing.

The method may comprise the step of configuring the housing between the first, locked state and the second, unlocked state.

The method may comprise the step of at least partially rotating the first part of the housing relative to the second part of the housing about an axis of rotation. The axis of rotation may be the longitudinal axis of the housing and/or the longitudinal axis of the fluid transfer apparatus. The method may comprise the step of configuring the housing between the first, locked state and the second, unlocked state by at least partially rotating the first part relative to the second part about the axis of rotation. The method may comprise the step of rotating the first part of the housing relative to the second part of the housing from a first point, in which the guide members of the first part and the second part are not substantially in alignment, to a second point, in which the guide members of the first part and the second part are substantially in alignment.

The method may comprise the step of connecting the first part of the housing to the fluid transfer device. The method may comprise the step of connecting the first part of the housing to an end portion, or end region, of the fluid transfer device.

The method may comprise the step of locating the fluid transfer device in at least part of the second part of the housing. The method may comprise the step of using the second part of the housing to receive at least a portion of the fluid transfer device. The method may comprise the step of moving the fluid transfer device relative to the second part of the housing when the housing is in the second, unlocked state. The method may comprise the step of locating the fluid transfer device in at least part of the first part of the housing and in at least part of the second part of the housing.

The method may comprise the step of securing the fluid transfer device in the second part of the housing when the fluid transfer apparatus is in the second coupled state. The method may comprise the step of engaging and locking the fluid transfer device in the second part of the housing when the fluid transfer apparatus is in the second coupled state. The method may comprise the step of permanently securing the fluid transfer device to the second part of the housing when the fluid transfer apparatus is in the second coupled state.

The method may comprise the step of using the fluid transfer device to open, pierce, puncture, penetrate, perforate, cut, slit, prick, spike, broach, breach, rupture, split, and/or fracture, at least a portion of the fluid receptacle. The method may comprise the step of using the fluid transfer device to open, pierce, puncture, penetrate, perforate, cut, slit, prick, spike, broach, breach, rupture, split, and/or fracture, at least a portion of the fluid receptacle when the fluid transfer apparatus is configured from the first isolation state to the second coupled state.

The method may comprise the step of using the one or more engagement members to open, pierce, puncture, penetrate, perforate, cut, slit, prick, spike, broach, breach, rupture, split, and/or fracture, at least a portion of the fluid receptacle when the fluid transfer apparatus is configured from the first isolation state to the second coupled state.

The method may comprise the step of using the fluid transfer apparatus to move the engagement member with respect to, or within, the fluid receptacle when the fluid receptacle is received and engaged by the fluid receptacle receiving portion. The method may comprise the step of arranging the engagement member substantially along the longitudinal axis of the fluid transfer apparatus.

The method may comprise the step of moving the, or each, engagement member into engagement with the fluid receptacle when the fluid transfer apparatus is configured from the first isolation state to the second coupled state. The method may comprise the step of moving the, or each, engagement member along the longitudinal axis of the fluid transfer apparatus into engagement with the fluid receptacle when the fluid transfer apparatus is configured from the first isolation state to the second coupled state.

The method may comprise the step of locating the fluid inlet substantially inside the fluid receptacle. The method may comprise the step of locating the fluid inlet substantially adjacent to a neck portion, a rim portion, an aperture, an opening, and/or an end region of the fluid receptacle.

The method may comprise the step of locking the fluid receptacle to the fluid receptacle receiving portion.

The method may comprise the step of using the fluid receptacle receiving portion to engage with and abut a collar portion, or an underside thereof, of the fluid receptacle.

The method may comprise the step of aligning the fluid receptacle to the fluid receptacle receiving portion. The method may comprise the step of aligning the longitudinal axis of the fluid receptacle to the longitudinal axis of the fluid transfer apparatus. The method may comprise the step of using the fluid transfer apparatus to align the fluid receptacle to the fluid transfer device.

The method may comprise the step of using the fluid receptacle receiving portion to engage and receive the fluid receptacle when the fluid transfer apparatus is in the first isolation state.

The method may comprise the step of connecting the fluid transfer apparatus to a further fluid transfer apparatus. The further fluid transfer apparatus may be a substance applicator for applying a substance to a human or animal body part. The method may comprise the step of engaging the fluid outlet of the fluid transfer apparatus with a fluid inlet of the further fluid transfer apparatus. The method may comprise the step of operating the further fluid transfer apparatus by hand.

It will be appreciated that the order that the steps are recited is only exemplary, and that the steps may be carried out in any order except where it is clear that a specific order is meant and/or a specific order is required or essential for the proper functioning of the method or process.

Embodiments of the third aspect of the present invention may include one or more features of the first and/or second aspects of the present invention or their embodiments. Similarly, embodiments of the first and/or second aspects of the present invention may include one or more features of the third aspect of the present invention or its embodiments.

According to a fourth aspect of the present invention there is provided a method of transferring fluid from a fluid receptacle to a further fluid transfer apparatus, the method comprising the steps of:

providing a fluid receptacle;
providing a fluid transfer system comprising:
a further fluid transfer apparatus, the further fluid transfer apparatus comprising a fluid inlet; and
a fluid transfer apparatus comprising:
a fluid inlet;
a fluid outlet; and
a fluid transfer device;
wherein the fluid inlet is associated with a fluid receptacle receiving portion, the fluid receptacle receiving portion being configured to receive and engage at least a portion of a fluid receptacle, and
wherein, in use, the fluid transfer apparatus is configurable between a first isolation state, in which the fluid transfer device is isolated from the fluid receptacle, such that the fluid container is fluidically isolated from the fluid inlet, to a second coupled state, in which the fluid transfer device is engaged with the fluid receptacle, such that the fluid receptacle is in fluid communication with the fluid inlet;
   wherein the fluid outlet of the fluid transfer apparatus is engageable with the fluid inlet of the further fluid transfer apparatus;
   using the fluid receptacle receiving portion to receive and engage at least a portion of the fluid receptacle;
   engaging the fluid outlet of the fluid transfer apparatus to the fluid inlet of the further fluid transfer apparatus; and
   transferring fluid from the fluid receptacle to the fluid inlet of the further fluid transfer apparatus by configuring the fluid transfer apparatus from the first isolation state to the second coupled state.

The further fluid transfer apparatus may be a substance applicator for applying a substance to a human or animal body part.

Embodiments of the fourth aspect of the present invention may include one or more features of the first, second and/or third aspects of the present invention or their embodiments. Similarly, embodiments of the first, second, and/or third aspects of the present invention may include one or more features of the fourth aspect of the present invention or its embodiments.

According to a fifth aspect of the present invention there is provided use of a fluid transfer apparatus with a further fluid transfer apparatus, the fluid transfer apparatus comprising:
a fluid inlet;
a fluid outlet; and
a fluid transfer device;
   wherein the fluid inlet is associated with a fluid receptacle receiving portion, the fluid receptacle receiving portion being configured to receive and engage at least a portion of a fluid receptacle, and
   wherein, in use, the fluid transfer apparatus is configurable between a first isolation state, in which the fluid transfer device is isolated from the fluid receptacle, such that the fluid container is fluidically isolated from the fluid inlet, to a second coupled state, in which the fluid transfer device is engaged with the fluid receptacle, such that the fluid receptacle is in fluid communication with the fluid inlet,
   and wherein the fluid outlet of the fluid transfer apparatus is engageable with the fluid inlet of the further fluid transfer apparatus.

The further fluid transfer apparatus may be a substance applicator for applying a substance to a human or animal body part. The substance may include an anaesthetic and/or an analgesic. The substance may include an anaesthetic and/or an analgesic in combination with one or more of the group consisting of: anaesthetics, analgesics, medicines, medicinal products, medicinal treatments, vaccines, anthelmintics, nutrients, micronutrients, minerals, vitamins, growth promotants, short acting growth promotants, tracer materials, animal identification materials, prophylactics, therapeutics, additives, insect control substances, wound dressings, bioactives, trace elements, validation markers.

Embodiments of the fifth aspect of the present invention may include one or more features of the first, second, third and/or fourth aspects of the present invention or their embodiments. Similarly, embodiments of the first, second, third and/or fourth aspects of the present invention may include one or more features of the fifth aspect of the present invention or its embodiments.

According to a sixth aspect of the present invention there is provided a kit of parts comprising:
a fluid receptacle; and
a fluid transfer apparatus comprising:
   a fluid inlet;
   a fluid outlet; and
   a fluid transfer device;
wherein the fluid inlet is associated with a fluid receptacle receiving portion, the fluid receptacle receiving portion being configured to receive and engage at least a portion of the fluid receptacle, and
wherein, in use, the fluid transfer apparatus is configurable between a first isolation state, in which the fluid transfer device is isolated from the fluid receptacle, such that the fluid container is fluidically isolated from the fluid inlet, to a second coupled state, in which the fluid transfer device is engaged with the fluid receptacle, such that the fluid receptacle is in fluid communication with the fluid inlet.

The fluid receptacle may include a fluid to be transferred from the fluid inlet to the fluid outlet of the fluid transfer apparatus.

The fluid may include an anaesthetic and/or an analgesic. The fluid may include an anaesthetic and/or an analgesic in combination with one or more of the group consisting of: anaesthetics, analgesics, medicines, medicinal products, medicinal treatments, vaccines, anthelmintics, nutrients, micronutrients, minerals, vitamins, growth promotants, short acting growth promotants, tracer materials, animal identification materials, prophylactics, therapeutics, additives, insect control substances, wound dressings, bioactives, trace elements, validation markers.

The kit of parts may comprise a further fluid transfer apparatus. The further fluid transfer apparatus may be a substance applicator for applying a substance to a human or animal body part. The further fluid transfer apparatus may comprise a fluid inlet, the fluid inlet being engageable with the fluid outlet of the fluid transfer apparatus.

Embodiments of the sixth aspect of the present invention may include one or more features of the first, second, third, fourth and/or fifth aspects of the present invention or their embodiments. Similarly, embodiments of the first, second, third, fourth and/or fifth aspects of the present invention may include one or more features of the sixth aspect of the present invention or its embodiments.

According to a seventh aspect of the present invention there is provided a fluid transfer apparatus comprising:
a fluid inlet;
a fluid outlet;
a fluid transfer device; and
a fluid receptacle, the fluid receptacle including a substance to be transferred from the fluid inlet to the fluid outlet of the fluid transfer apparatus;
   wherein the fluid inlet is associated with a fluid receptacle receiving portion, the fluid receptacle receiving portion being configured to receive and engage at least a portion of a fluid receptacle, and
   wherein, in use, the fluid transfer apparatus is configurable between a first isolation state, in which the fluid transfer device is isolated from the fluid receptacle, such that the fluid container is fluidically isolated from the fluid inlet, to a second coupled state, in which the fluid transfer device is engaged with the fluid receptacle, such that the fluid receptacle is in fluid communication with the fluid inlet.

The substance may include an anaesthetic and/or an analgesic. The substance may include an anaesthetic and/or an analgesic in combination with one or more of the group consisting of: anaesthetics, analgesics, medicines, medicinal products, medicinal treatments, vaccines, anthelmintics, nutrients, micronutrients, minerals, vitamins, growth promotants, short acting growth promotants, tracer materials, animal identification materials, prophylactics, therapeutics, additives, insect control substances, wound dressings, bioactives, trace elements, validation markers.

Embodiments of the seventh aspect of the present invention may include one or more features of the first, second, third, fourth, fifth and/or sixth aspects of the present invention or their embodiments. Similarly, embodiments of the first, second, third, fourth, fifth and/or sixth aspects of the present invention may include one or more features of the seventh aspect of the present invention or its embodiments.

### BRIEF DESCRIPTION OF THE DRAWINGS

Embodiments of the invention will now be described, by way of example, with reference to the drawings, in which:

FIGS. 1a to 1g show a fluid transfer apparatus according to an embodiment of the present invention;

FIGS. 2a and 2b show the fluid transfer apparatus of FIGS. 1a to 1g in the first isolation state;

FIGS. 3a and 3b show the fluid transfer apparatus of FIGS. 1a to 1 g in the second coupled state;

FIGS. 4a to 4c show a partial view of the fluid transfer apparatus of FIGS. 1a to 1g in the first isolation state;

FIGS. 4d and 4e show a partial view of the fluid transfer apparatus of FIGS. 1a to 1g in the second coupled state;

FIG. 5 shows the fluid transfer apparatus of FIGS. 1a to 1g engaged with a further fluid transfer apparatus;

FIG. 6 is a schematic showing two fluid transfer apparatus of FIGS. 1a to 1g engaged with a further fluid transfer apparatus; and

FIG. 7 shows an alternative embodiment of the fluid transfer device of the fluid transfer apparatus of FIGS. 1a to 1g.

### DESCRIPTION OF PREFERRED EMBODIMENTS

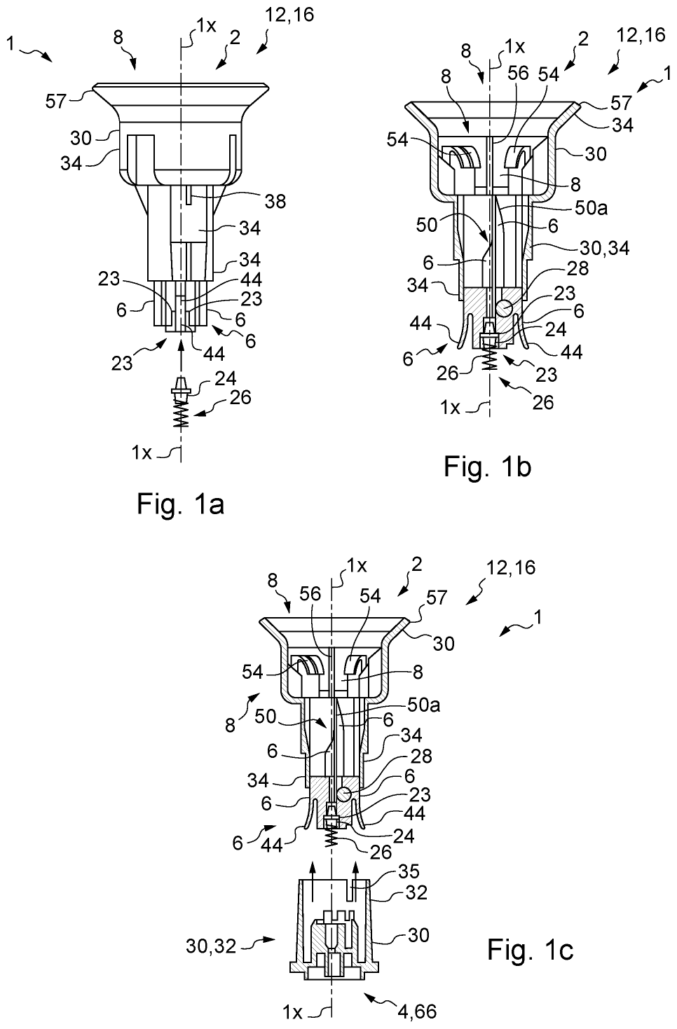

With reference to FIGS. 1a to 6 a fluid transfer apparatus 1 comprising a fluid inlet 2, a fluid outlet 4 and a fluid transfer device 6 is shown. The fluid inlet 2 is associated with a fluid receptacle receiving portion 8, and the fluid receptacle receiving portion 8 is configured to receive and engage at least a portion of a fluid receptacle 10. The fluid transfer apparatus 1 is a substantially rigid member and is configured for use in an agricultural environment or setting.

The present invention is particularly well suited for use with fluid receptacles 10 that must be kept sterile prior to use, as the user cannot re-use the fluid transfer apparatus 1 by removing a used, potentially non-sterile fluid receptacle 10, and replacing it with a new, fluid receptacle 10. As the fluid transfer apparatus 1 is typically stored prior to engagement with a fluid receptacle 10, it is therefore easier to mitigate the build up of debris, and other residue, on the fluid transfer apparatus 1 prior to use with the fluid receptacle 10. In contrast, known fluid transfer apparatus 1, particularly in an agricultural or medical setting, are thought to often be intentionally re-used by the end-user despite the increased likelihood of accumulating debris, or other contamination, on the fluid transfer apparatus 1. However, it will be appreciated that in other embodiments the fluid transfer apparatus 1 could be configured such that a used fluid receptacle 10 could be replaced.

Furthermore, the fluid transfer apparatus 1 is operable to automatically align the fluid receptacle 10 to the fluid transfer apparatus 1, and to lock the fluid receptacle 10 to the fluid transfer apparatus 1, in a safe, reliable and efficient manner.

In the embodiments illustrated and described here, the fluid receptacle receiving portion 8 stabilises the fluid container 10 in use, which will be described in more detail below.

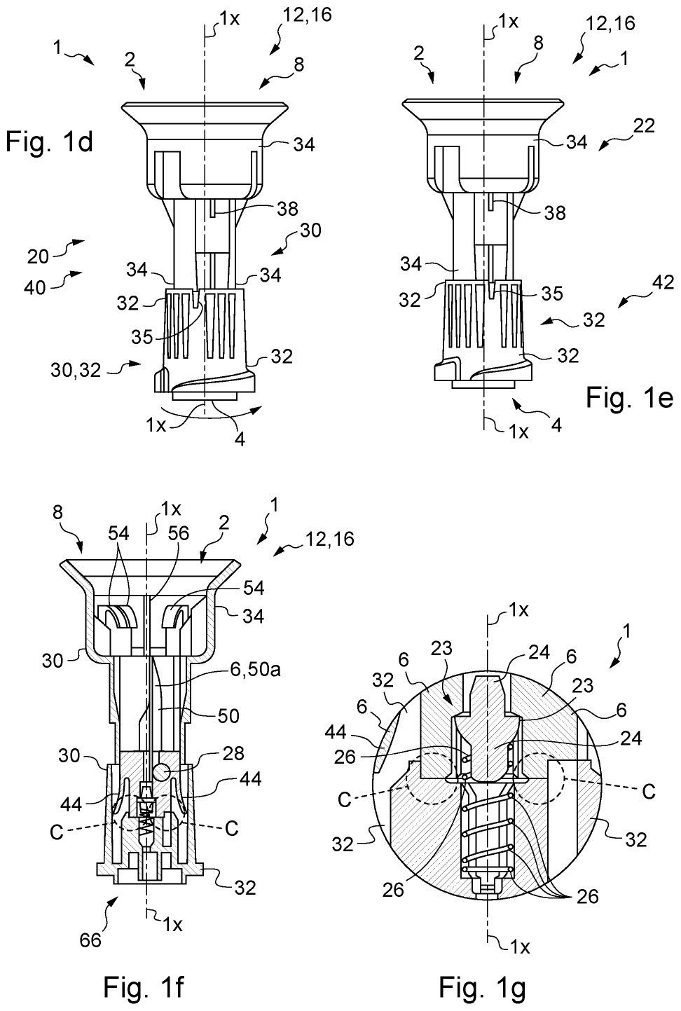

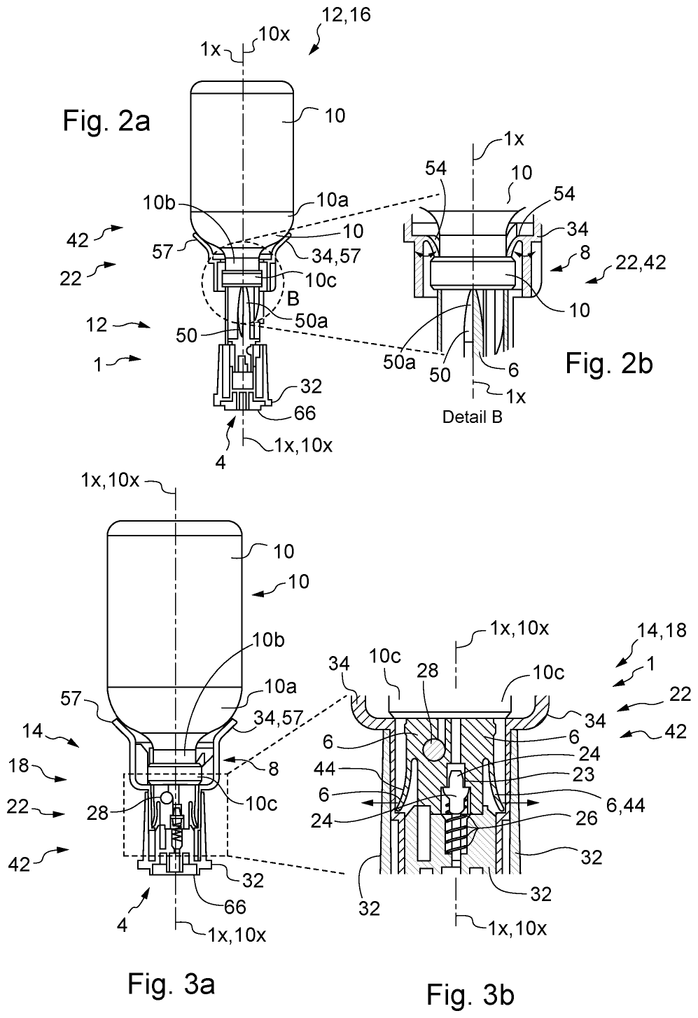

In use, the fluid transfer apparatus 1 is configurable from a first isolation state 12 (FIG. 2a), in which the fluid transfer device 6 is isolated from the fluid receptacle 10, such that the fluid container 1 is fluidically isolated from the fluid inlet 2, to a second coupled state 14 (FIG. 3a), in which the fluid transfer device 6 is engaged with the fluid receptacle 10, such that the fluid receptacle 10 is in fluid communication with the fluid inlet 2.

The fluid transfer apparatus 1 is configured such that a fluid flow path exists from the fluid inlet 2, to the fluid transfer device 6, to the fluid outlet 4, such that, in use and in the second coupled state 14, fluid can flow from the fluid receptacle 1 to the fluid outlet 4 via the fluid flow path.

The fluid transfer apparatus 1 is operable to lock the fluid transfer device 6 in the second coupled state 14. In the embodiments illustrated and described here, the fluid transfer apparatus 1 is irreversibly configurable in the second coupled state 14, and the fluid transfer device 6 cannot be unlocked from the second coupled state 14. That is, the fluid transfer apparatus 1 is configurable from the first isolation state 12 to the second coupled state 14 and prevented from returning to the first isolation state 12. Therefore, in the embodiments illustrated and described here, when the fluid transfer apparatus 1 is in the second coupled state 14, the fluid transfer device 1 is secure and cannot be moved back to the first isolation state 12. This makes the fluid transfer apparatus 1 safer and more reliable to use, particularly with fluid receptacles 10 containing fluids that must be kept sterile. However, it should be appreciated that in other embodiments, the fluid transfer apparatus 1 could be configurable between the first isolation state 12 and the second coupled state 14.

In the embodiments illustrated and described here, the fluid transfer apparatus 1 is operable to irreversibly move the fluid transfer device 6 between a first position 16 and second position 18 when the fluid transfer apparatus 1 is configured between the first isolation state 12 and the second coupled state 14, such that the fluid transfer device 6 is locked at the second position 18. It should be appreciated that in other embodiments, when the fluid transfer apparatus 1 is configured between the first isolation state 12 and the second coupled state 14, the fluid transfer device 6 may not be movable.

As best shown in FIGS. 2a to 3b, the fluid transfer apparatus 1 is operable to open at least a portion of the fluid receptacle 10 by piercing it, which allows fluid to flow from the fluid receptacle 10. It will be appreciated that the fluid transfer apparatus 1 could be operable to open, pierce, puncture, penetrate, perforate, cut, slit, prick, spike, broach, breach, rupture, split, and/or fracture at least a portion of the fluid receptacle 10.

As best shown in FIGS. 1d and 1e, the fluid transfer apparatus 1 is configurable between a locked state 20 (FIG. 1d) and an unlocked state 22 (FIG. 1e). In the locked state 20, the fluid transfer apparatus 1 is prevented from being configurable between the first isolation state 12 and the second coupled state 14. In the unlocked state 22, the fluid transfer apparatus 1 is configurable between the first isolation state 12 and the second coupled state 14. This mitigates the risk of the fluid transfer apparatus 1 being unintentionally locked at the second coupled state 14 prior to use, which could result in the fluid transfer device 6 being more likely to accumulate debris and possibly becoming damaged.

The fluid receptacle receiving portion 8 is configured to connect and irreversibly secure at least a portion of the fluid receptacle 10 thereto. In the embodiments illustrated and described here, the fluid receptacle receiving portion 8 is configured to lock at least a portion of the fluid receptacle 10 with the fluid receptacle receiving portion 8 and the fluid receptacle 10 cannot be removed from the fluid receptacle receiving portion 8 when located therein. That is, the fluid receptacle receiving portion 8 is configured to prevent removal of at least a part of the fluid receptacle 10 from the fluid receptacle receiving portion 8 when the at least a portion of the fluid receptacle 10 is locked with the fluid receptacle receiving portion 8. It is advantageous to secure the fluid receptacle 10 to the fluid transfer apparatus 1 in this manner, as the fluid receptacle 10 is more stable during use and is less likely to break free from the fluid transfer apparatus 1.

The fluid transfer apparatus 1 is configured to shield and protect at least a portion of the fluid transfer device 6 in the first isolation state, which helps to prevent the fluid transfer device 6 from being damaged.

In the embodiments illustrated and described here, in the second coupled state 14 the fluid transfer apparatus 1 is configured to allow fluid to flow from the fluid inlet 2 to the fluid outlet 4 and to substantially prevent fluid flow from the fluid outlet 4 to the fluid inlet 2. In this arrangement, the fluid transfer apparatus 1 is configured to allow substantially unidirectional fluid flow from the fluid inlet 2 to the fluid outlet 4. As best shown in FIG. 1g, the fluid transfer device 6 comprises a valve accommodating portion 23 configured to receive a one-way liquid permeable valve 24, which is designed for unidirectional fluid flow. It will be appreciated that other types of valve could be used.

As illustrated in FIG. 1g, the fluid transfer device 6 is configured to bias the valve 24 in the closed position by way of a biasing member, which in this embodiment is a helical compression spring 26 (an example of a spring member). It should be understood that other types of biasing member may be used, such as other types of spring members and/or a resilient member, such as a rubber member.

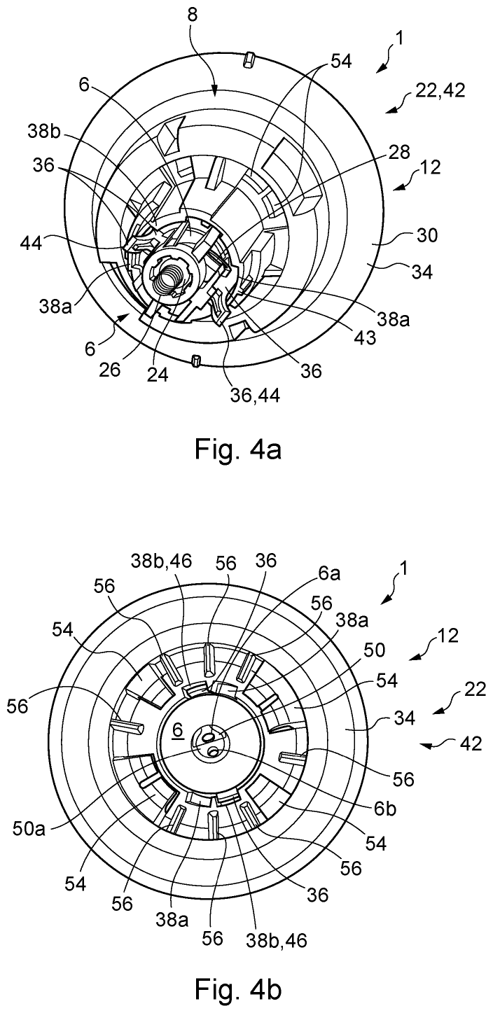

In the embodiments illustrated and described here, and with reference to FIGS. 3b and 4a, the fluid transfer device 6 comprises a further fluid inlet 28, which in this embodiment is a hydrophobic valve configured to be liquid-impermeable and gas-permeable. Thus, the fluid transfer apparatus 6 is configured to allow a first fluid to flow from the fluid inlet 2 to the fluid outlet 4, and to allow a second fluid to flow from the further fluid inlet 28 to the fluid inlet 2 of the fluid transfer apparatus 10, and in use, into the fluid receptacle 10. The first fluid is typically a liquid, although it will be appreciated that the first fluid could be a liquid/gas mixture. The second fluid is typically atmospheric air, although it will be appreciated that other gas(es) could be used.

The fluid transfer apparatus 1 comprises a housing 30 configured to accommodate at least a portion of the fluid transfer device 6.

The housing 30 is configured to permit movement of the fluid transfer device 6 between the first position 16 and second position 18 when the fluid transfer apparatus 1 is configured between the first isolation state 12 and the second coupled state 14 and to substantially prevent movement of the fluid transfer device 6 from the second position 18 to the first position 16. The housing 30 is configured to allow locking of the fluid transfer device 6 at the second position 18.

As best shown in FIGS. 2a to 3b, the housing 30 comprises a first part 32 and a second part 34. The first part 32 of the housing 30 is associated with the fluid outlet 4 of the fluid transfer apparatus 1 and the second part 34 of the housing 30 is associated with the fluid inlet 2 of the fluid transfer apparatus 1. The second part 34 of the housing 30 includes the fluid receptacle receiving portion 8. The housing 30 is configured to permit relative movement of the first and second parts 32, 34 along a longitudinal axis 1x of the fluid transfer apparatus 1. In use, the housing 30 is configured to permit the second part 34 to move relative to the first part 32 and relative to the fluid receptacle 10 and, in use, the second part 34 is fixed relative to the fluid receptacle 10.

As shown in FIGS. 1d and 1 e, the housing 30 is configurable between a first, locked state 20, in which the fluid transfer apparatus 1 is prevented from being configured between the first isolation state 12 and the second coupled state 14, and a second, unlocked state 22, in which the fluid transfer apparatus 1 can be configured between the first isolation state 12 and the second coupled state 14. In the second, unlocked state 22, the first part 32 of the housing 30 is movable relative to the second part 34 of the housing 30 along the longitudinal axis 1x of the fluid transfer apparatus 1.

As shown in FIGS. 1d and 1e, the first part 32 and the second part 34 of the housing 30 comprise one or more guide members 35, 38, configured to permit movement of the first part 32 relative to the second part 34 along the longitudinal axis 1x of the fluid transfer apparatus 1. In this embodiment, the guide members 35, 38 are one or more grooves present on the first part 32 of the housing 30 and one or more corresponding ribs present on the second part 34 of the housing 30.

With reference to FIGS. 4a to 4e, the fluid transfer device 6 comprises one or more guide members 36 configured to engage with corresponding guide members 38 of the second part 34 of the housing 30. In the embodiment illustrated and described here, the second part 34 of the housing 30 comprises first and second guide members 38a, 38b. The first guide members 38a are configured to engage with the guide members 36 of the fluid transfer device 6 and to permit movement of the fluid transfer device 6 along the longitudinal axis 1x of the fluid transfer apparatus 1. The first guide members 38a are designed to allow the fluid transfer device 6 to be located in the second part 34 of the housing 30 during the assembly phase of the fluid transfer apparatus 1. The second guide members 38b have the same function as the first guide members 38a, although they are designed to permit the fluid transfer device 6 to irreversibly move to the second position 18, as will be described in more detail below.

In the embodiments illustrated and described here, the housing 30 is configured such that the first part 32 is at least partially rotatable relative to the second part 34 about the longitudinal axis 1x of the fluid transfer apparatus 1. The housing 30 is configurable between the first, locked state 20 and the second, unlocked state 22 when the first part 32 is at least partially rotated relative to the second part 34 about the longitudinal axis 1x of the fluid transfer apparatus 1.

Rotating the first part 32 of the housing 30 relative to the second part 34 of the housing moves the guide members 36 of the fluid transfer device 6 out of alignment with the first guide members 38a of the second part 34 of the housing 30 and brings the guide members 36 into alignment with the second guide members 38b of the second part 34 of the housing 30.

The housing 30 is configured such that the first part 32 is rotatable relative to the second part 34 from the first point 40 to the second point 42, and such that the first part 32 cannot be rotated from the second point 42 back to the first point 40. In this arrangement, the first part 32 is irreversibly rotatable from the first point 40 to the second point 42. The second part 34 of the housing 30 comprises a latch member 43 configured to allow the guide members 36 of the fluid transfer device 6 to move from the first guide members 38a to the second guide members 38b of the second part 34 of the housing 34 when the first part 32 is rotated relative to the second part 34.

In this embodiment, movement of the first part 32 of the housing 30 results in relative movement of the fluid transfer device 6 as the first part 32 of the housing 30 is fixed to an end region of the fluid transfer device 6.

The fluid transfer device 1 is locatable in at least part of the first part 32 and the second part 34 of the housing 30, and the first and second part 32, 34 of the housing 30 are configured to receive at least a portion of the fluid transfer device 6.

In the embodiments illustrated and described here, the second part 34 of the housing 30 is configured to secure the fluid transfer device 6 therein when the fluid transfer apparatus 1 is in the second coupled state 14. The second part 34 of the housing 30 is configured to engage and lock the fluid transfer device 6 therein when the fluid transfer apparatus 1 is in the second coupled state 14. The second part 34 of the housing 30 is configured to permanently secure the fluid transfer device 6 to the second part 34 of the housing 30 when the fluid transfer apparatus 1 is in the second coupled state 14. The second part 34 of the housing 30 is configured to prevent removal of the fluid transfer device 6 from the second part 34 of the housing 30 when the fluid transfer apparatus 1 is in the second coupled state 14.

In the embodiments illustrated and described here, the fluid transfer device 6 comprises one or more engagement members 44 located within the first part 32 of the housing 30, when the fluid transfer apparatus 1 is in the first isolation state 12, the one or more engagement members 44 being configured to engage with the second part 34 of the housing 30 when the fluid transfer apparatus 1 is in the second coupled state 14. The engagement members 44 are configured to engage with corresponding engagement members 46 of the second part 34 of the housing 30.

As best shown in FIGS. 1b and 4a, the engagement members 44 of the fluid transfer device 6 are one or more substantially resilient flaps and the corresponding engagement members 46 of the second part 34 of the housing 30 are slots, configured to receive the engagement members 44 of the fluid transfer device 6. However, it should be understood that the engagement members 44 of the fluid transfer device 6 could be one or more tabs, lips, flaps, protruding members, and/or protrusions, or the like. It should be understood that the engagement members 46 of the second part 34 of the housing 30 could be one or more holes, apertures, grooves, channels, or the like.

The engagement members 44 of the fluid transfer device 6 and the corresponding engagement members 46 of the second part 34 of the housing 30 are configured to permanently secure the fluid transfer device 6 at the second coupled state 14 and to prevent removal of the fluid transfer device 6 from the second coupled state 14.

In the embodiment illustrated and described here, the first part 32 and the second part 34 of the housing 30 are separately formed and the housing 30 is a substantially rigid member.

The fluid transfer device 6 includes a fluid inlet 6a defined by an opening in the fluid transfer device 6. The fluid inlet 6a of the fluid transfer device 6 is located adjacent to an end region of the fluid transfer device 6. As best shown in FIGS. 4a to 4e, the fluid transfer device 6 also includes an opening 6b configured to allow fluid to flow from the further fluid inlet 28 of the fluid transfer device 6 to, in use, the fluid receptacle 10.

The fluid transfer device 1 comprises an engagement member 50 for engaging the fluid receptacle 10. The engagement member 50 comprises a spike member 50a and is configured to pierce at least a portion of the fluid receptacle 10 when the fluid transfer apparatus 1 is configured from the first isolation state 12 to the second coupled state 14. However, it should be understood that the engagement member 50 could comprise a piercing member, a pin member, and/or a nail member, or the like.

As best shown in FIGS. 2a to 3a, the fluid transfer apparatus 1 is configured to move the engagement member 50 with respect to, or within, the fluid receptacle 10 when the fluid receptacle 10 is received and engaged by the fluid receptacle receiving portion 8. The fluid transfer apparatus 1 is configured to arrange the engagement member 50 substantially along the longitudinal axis 1x of the fluid transfer apparatus 1, which helps to mitigate the engagement member 50 snagging, being damaged, or becoming dislodged from the fluid transfer apparatus 1 and becoming lodged within the fluid receptacle 10.

In the embodiments illustrated and described here, the engagement member 50 includes the fluid inlet 6a of the fluid transfer device 6, and the opening 6b for allowing fluid to flow from the further fluid inlet 28. The engagement member 50 includes the fluid inlet 2 of the fluid transfer apparatus 1 and, in use, fluid can flow from the fluid receptacle 10, through the fluid inlet 2, 6a, located on the engagement member 50. Thus, the fluid transfer apparatus 1 comprises a fluid flow path from the fluid receptacle 10 to the engagement member 50 of the fluid transfer device 6 to the fluid outlet 4.

It will be appreciated that, whilst in this embodiment, the fluid inlet 6a of the fluid transfer device 6 and the fluid inlet 2 of the fluid transfer apparatus 1 are both defined by an opening in the engagement member 50, other arrangements are possible.

The fluid transfer apparatus 1 is configured to allow movement of the engagement member 50 along the longitudinal axis 1x of the fluid transfer apparatus 1 into engagement with the fluid receptacle 10 when the fluid transfer apparatus 1 is configured from the first isolation state 12 to the second coupled state 14.

The fluid transfer apparatus 1 is configured to prevent the engagement member 50 from protruding beyond, or outside of, the housing 10 and the fluid transfer apparatus 1 is configured to protect, or shield, the engagement member 50 when the fluid transfer apparatus 1 is configured in the first isolation state 12.

The fluid transfer device 6 is a substantially rigid member.

As best shown in FIGS. 1f and 2a, the fluid transfer apparatus 1 is configured such that, in the first isolated state 12, the fluid inlet 2 is located distal to, or outside the fluid receptacle receiving portion 8, and in the second coupled state 14, the fluid inlet 2 is located proximal to, or inside, the fluid receptacle receiving portion 8.

The fluid transfer apparatus 1 is configured such that, in the second coupled state 14, the fluid inlet 2 is located substantially inside the fluid receptacle 10, and such that the fluid inlet 2 is located substantially adjacent to an end region of the fluid receptacle 10. In this way, the amount of fluid that can be transferred from the fluid receptacle 10 to the fluid transfer apparatus 1 through the fluid inlet 2 is maximised.

The fluid outlet 4 of the fluid transfer apparatus 1 is located at an end region of the fluid transfer apparatus 1, and at an opposite region, or part, of the fluid transfer apparatus 1 to the fluid inlet 2. In the embodiments illustrated and described here, the fluid outlet 4 is an opening located on the first part 32 of the housing 30 of the fluid transfer apparatus 1.

The fluid receptacle receiving portion 8 comprises one or more locking members 54 configured to lock the fluid receptacle 10 to the fluid receptacle receiving portion 8. The fluid receptacle receiving portion 8 is configured to engage with the fluid receptacle 10 in an interference fit. The locking members 54 are one or more hooks and are at least partially resilient members. The one or more locking members 54 are configured to engage with at least a portion of the fluid receptacle 10 in an interference fit. As best shown in FIG. 2b, the locking members 54 are arranged to engage with and abut a collar portion, and particularly an underside thereof, of the fluid receptacle 10.

In the embodiments illustrated and described here, the fluid receptacle receiving portion 8 is configured to substantially prevent movement of the fluid receptacle 10 relative to the fluid transfer apparatus 1 when the fluid receptacle 10 is received and engaged by the fluid receptacle receiving portion 8.

At least a part of the fluid receptacle receiving portion 8 is configured to support at least a part of the fluid receptacle 10. The fluid receptacle receiving portion 8 comprises one or more first support members 56 configured to support the fluid receptacle 10. The first support members 56 of the fluid receptacle receiving portion 8 are ribs.

The fluid transfer apparatus 1 is configured to align the fluid receptacle 8 to the fluid transfer device 6 and the fluid receptacle receiving portion 8 is configured to substantially align a longitudinal axis 10x of the fluid receptacle 10 and the longitudinal axis 1x of the fluid transfer apparatus 1.

The fluid receptacle receiving portion 8 is a substantially rigid member and the locking members 54 of the fluid receptacle receiving portion 8 are at least partially resilient members.

The fluid receptacle receiving portion 8 comprises a second support member 57 configured to, in use, provide support to the fluid receptacle 10, and in the embodiments described here the second support member 57 is a collar member.

The second support member 57 is correspondingly shaped to a shoulder portion 10a and a neck portion 10b of the fluid receptacle 10.

The fluid receptacle receiving portion 8 has a substantially circular cross section along the longitudinal axis 1x of the fluid transfer apparatus 1 and the fluid receptacle receiving portion 8 is shaped to receive and support the shoulder portion 10a, the neck portion 10b and a head portion 10c of the fluid receptacle 10. The fluid receptacle receiving portion 8 is configured to slidably engage with at least a part of the fluid receptacle 10. The fluid receptacle receiving portion 8 is configured to snugly fit with the shoulder portion 10a, neck portion 10b and the head portion 10c of the fluid receptacle 10.

As best shown in FIG. 2a, the fluid transfer apparatus 1 is configured such that, in the first isolation state 12 the fluid transfer device 6 is remote from the fluid receptacle 10. The fluid transfer apparatus 1 is configured such that, in the first isolation state 12, the fluid transfer device 6 is substantially separate from the fluid receptacle 10. The fluid transfer apparatus 1 is configured such that, in the first isolation state 12, the fluid transfer device 6 is substantially distal from the fluid receptacle 10. The fluid transfer apparatus 1 is configured such that, in the first isolation state 12, the fluid transfer device 6 is spaced from the fluid receptacle 10. The fluid transfer apparatus 1 is configured such that, in the first isolation state 12, the fluid transfer device 6 is substantially not in contact with the fluid receptacle 10.

The housing 30 is configured such that, in the first isolation state 12, the housing 30 can be configured between the locked state 20 and the unlocked state 22.

In the first isolation state 12, the fluid receptacle 10 can be engaged and received by the fluid receptacle receiving portion 8.

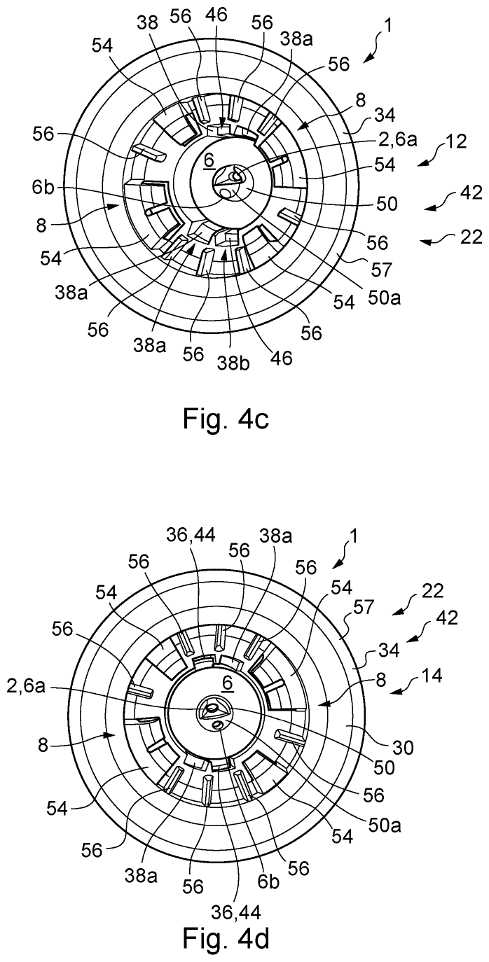

As shown in FIG. 5, the fluid transfer apparatus 1 is connectable to a further fluid transfer apparatus 60, which in this embodiment is a hand-held substance applicator for applying a substance to a human or animal body part. The fluid outlet 4 of the fluid transfer apparatus 1 is engageable with a fluid inlet 62 of the further fluid transfer apparatus 60. The fluid transfer apparatus 1 is configured such that, in use, fluid can flow from the fluid receptacle 10 to the fluid inlet 62 of the further fluid transfer apparatus 60 when the fluid transfer apparatus 1 is engaged with the further fluid transfer apparatus 60.

In the embodiments illustrated and described here, the fluid outlet 4 of the fluid transfer apparatus 1 is configured to be engageable only with the fluid inlet 62 of the further fluid transfer apparatus 60, and the fluid inlet 62 of the further fluid transfer apparatus 60 is configured to be engageable only with the fluid outlet 4 of the fluid transfer apparatus 1.

The fluid outlet 4 of the fluid transfer apparatus 1 is configured such that it cannot engage with other device(s), and can only engage with the fluid inlet 62 of the further fluid transfer apparatus 60. The fluid inlet 62 of the further fluid transfer apparatus 60 is configured such that it cannot engage with other device(s), and can only engage with the fluid outlet 4 of the fluid transfer apparatus 1.

The fluid transfer apparatus 1 includes a connection means 64 configured to connect with a corresponding connection means 66 of the further fluid transfer apparatus 60, and in this embodiment, the connection means 64, 66 is a custom, non-standard Luer lock.

As best shown in FIG. 5, the fluid transfer apparatus 1 is configured to provide support to the fluid receptacle 10 when at least a portion of the fluid receptacle 10 is received and engaged by the fluid receptacle receiving portion 8. This makes the fluid transfer apparatus 1 more compact, as the fluid transfer apparatus 1 and the fluid receptacle 10 can be mounted in, for example, a vertical orientation.

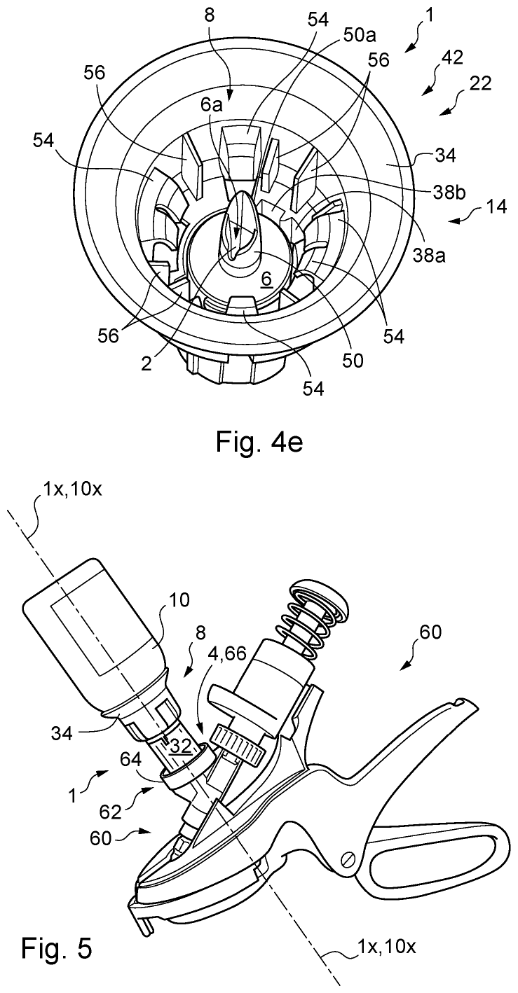

As shown in FIG. 6, the further fluid transfer apparatus 60 could comprise one or more fluid inlets 62 and each fluid inlet 62 is engageable with a fluid outlet 4 of a fluid transfer apparatus 1. In this arrangement, a plurality of fluid transfer apparatuses 1 are engaged with the further fluid transfer apparatus 60. Each fluid receptacle 10 could include a fluid, and each of the fluids could be the same fluid, or could be different fluids. It will be appreciated that the fluids from each fluid receptacle 10 could be mixed within the further fluid transfer apparatus 60.

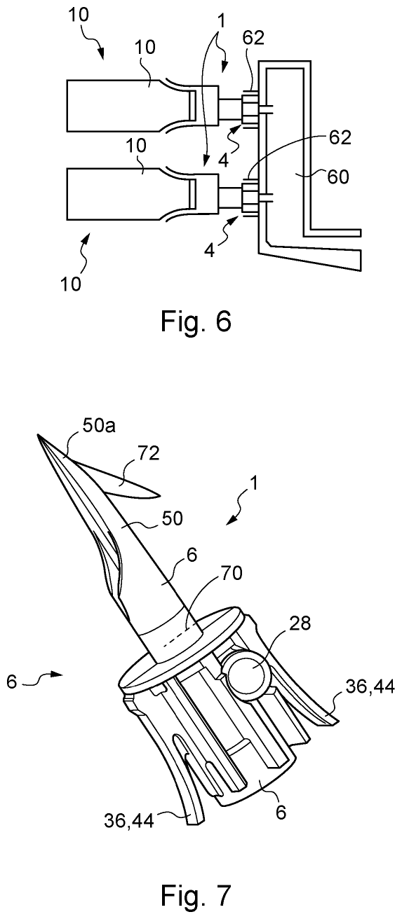

FIG. 7 shows an alternative embodiment of the fluid transfer device 6, in which the engagement member 50 is configured such that it cannot be removed from the fluid receptacle 10 when the engagement member 50 is located in the fluid receptacle 10 when the fluid transfer apparatus 1 is configured in the second coupled state 14. In this alternative embodiment, the engagement member 50 comprises one or more locking members 72 configured to prevent the engagement member 50 being removed from the fluid receptacle 10 when the engagement member 50 is at least partially located in the fluid receptacle 10. In this alternative embodiment, the locking member 72 of the engagement member 50 is one or more barb members configured to allow the engagement member 50 to be located at least partially within the fluid receptacle 10 and configured to prevent the engagement member 50 from being removed from the fluid receptacle 10.

In the alternative embodiment shown in FIG. 7 at least a portion of the engagement member 50 for engaging the fluid receptacle comprises a frangible portion 70, such that, the attempted removal of the engagement member 50 from the fluid receptacle 10 results in the engagement member 50 being fractured or broken. This further reduces the likelihood that the fluid transfer apparatus 1 will be re-used by the end-user.

In use, the fluid transfer apparatus 1 can be used in the following manner. With reference to FIG. 1a, which shows the fluid transfer device 6 located in the second part 34 of the housing 30, the liquid-permeable valve 24 is located within the valve accommodating portion 23 of the fluid transfer device 6 (as shown in FIG. 1b), and the first part of the housing 32 is then engaged with the fluid transfer device 6 (FIG. 1c). In this embodiment, the first part 32 of the housing 34 is ultrasonically welded to the fluid transfer device 6, although it will be appreciated that other methods could be used.

The next step can be carried out in at least two different ways. For example, the first part 32 of the housing 30 can be rotated relative to the second part 34 (as shown in FIGS. 1d and 1 e), to configure the housing 30 between the locked 20 and unlocked states 22, and the fluid receptacle 10 can then be received and engaged by the fluid receptacle receiving portion 8, as shown in FIG. 2a. Alternatively, the user of the fluid transfer apparatus 1 can locate at least a portion of the fluid receptacle 10 in the fluid receptacle receiving portion 8 and then rotate the first part 32 of the housing 30 relative to the second part 34. In any event, once the housing 30 is in the unlocked state 22 and the fluid receptacle 10 is received and engaged by the fluid receptacle receiving portion 8, the user can then configure the fluid transfer apparatus 1 from the first isolation state 12 (FIG. 2a) to the second coupled state 14 (FIG. 3a), in which the spike member 50a of the engagement member 50 of the fluid transfer device 6 pierces the fluid receptacle 10, such that fluid can then flow from the fluid receptacle 10 to the fluid outlet 4 of the fluid transfer apparatus 1 via the engagement member 50. With reference to FIG. 5, the fluid transfer apparatus 1 is typically then mounted to a further fluid transfer apparatus 60, which can be used to control the flow of fluid from the fluid receptacle 10.

Modifications and improvements may be made to the foregoing embodiments without departing from the scope of the invention. For example, the fluid transfer apparatus 1 may comprise one or more fluid inlets 2. The fluid transfer apparatus 1 may comprise one or more fluid outlets 4.

Whilst in the embodiments illustrated and described here, the housing 30 is a two-piece housing, it should be appreciated that the housing 30 could comprise any number of individual parts.

It should be appreciated that the fluid transfer apparatus 1 could be configured to engage and receive other types of fluid receptacle 10.

1. A fluid transfer apparatus comprising:
a fluid inlet;
a fluid outlet; and
a fluid transfer device;
wherein the fluid inlet is associated with a fluid receptacle receiving portion, the fluid receptacle receiving portion being configured to receive and engage at least a portion of a fluid receptacle, and
wherein, in use, the fluid transfer apparatus is configurable between a first isolation state, in which the fluid transfer device is isolated from the fluid receptacle, such that the fluid container is fluidically isolated from the fluid inlet, to a second coupled state, in which the fluid transfer device is engaged with the fluid receptacle, such that the fluid receptacle is in fluid communication with the fluid inlet.

2. The fluid transfer apparatus of claim 1, wherein the fluid transfer apparatus is configurable from the first isolation state to the second coupled state and prevented from returning to the first isolation state.

3. The fluid transfer apparatus of claim 1, wherein the fluid transfer apparatus is operable to move the fluid transfer device between a first and second position when the fluid transfer apparatus is configured between the first isolation state and the second coupled state.

4. The fluid transfer apparatus of claim 1, wherein the fluid transfer apparatus is operable to lock the fluid transfer device in the second coupled state, such that the fluid transfer device may not be unlocked from the second coupled state.

5. The fluid transfer apparatus of claim 1, wherein the fluid receptacle receiving portion is configured to lock at least a portion of the fluid receptacle with the fluid receptacle receiving portion, the fluid receptacle receiving portion being configured to prevent removal of at least a part of the fluid receptacle from the fluid receptacle receiving portion when the at least a portion of the fluid receptacle is locked with the fluid receptacle receiving portion.

6. The fluid transfer apparatus of claim 1, wherein the fluid transfer apparatus comprises a housing configured to accommodate at least a portion of the fluid transfer device.

7. The fluid transfer apparatus of claim 6, wherein the housing is configurable between a first, locked state, in which the fluid transfer apparatus is prevented from being configured between the first isolation state and the second coupled state, and a second, unlocked state, in which the fluid transfer apparatus can be configured between the first isolation state and the second coupled state.

8. The fluid transfer apparatus of claim 6, wherein the housing comprises a first part and a second part, and wherein the first part, the second part and/or the fluid transfer device comprises one or more guide members configured to permit movement of the fluid transfer device relative to the first part and/or the second part along the longitudinal axis of the fluid transfer apparatus.

9. The fluid transfer apparatus of claim 7, wherein the housing is configured such that the first part is rotatable relative to the second part from a first point, in which the guide members of the fluid transfer device and the first part and/or the second part are not substantially in alignment, to a second point, in which the guide members of the fluid transfer device and the first part and/or the second part are substantially in alignment.

10. The fluid transfer apparatus of claim 9, wherein the housing is configured such that the first part is rotatable relative to the second part from the first point to the second point, and such that the first part cannot be rotated from the second point back to the first point.

11. The fluid transfer apparatus of claim 6, wherein the second part of the housing is configured to engage and lock the fluid transfer device therein when the fluid transfer apparatus is in the second coupled state, the second part of the housing being configured to permanently secure the fluid transfer device therein when the fluid transfer apparatus is in the second coupled state.

12. The fluid transfer apparatus of claim 1, wherein the fluid transfer device comprises one or more engagement members configured to be located within the first part of the housing, when the fluid transfer apparatus is in the first isolation state, the one or more engagement members being configured to engage with the second part of the housing when the fluid transfer apparatus is in the second coupled state, and wherein the engagement members of the fluid transfer device are configured to permanently secure the fluid transfer device at the second coupled state.

13. The fluid transfer apparatus of claim 1, wherein the fluid transfer device is configured to open, pierce, puncture, penetrate, perforate, cut, slit, prick, spike, broach, breach, rupture, split, and/or fracture, at least a portion of the fluid receptacle when the fluid transfer apparatus is configured from the first isolation state to the second coupled state.

14. The fluid transfer apparatus of claim 1, wherein the fluid transfer device comprises one or more engagement members for engaging the fluid receptacle, wherein the engagement member is a substantially protruding member.

15. The fluid transfer apparatus of claim 14, wherein the fluid transfer apparatus is configured to move the engagement member along the longitudinal axis of the fluid transfer apparatus.

16. The fluid transfer apparatus of claim 14, wherein the fluid transfer apparatus is configured to shield the engagement member when the fluid transfer apparatus is configured in the first isolation state.

17. The fluid transfer apparatus of claim 1, wherein the fluid receptacle receiving portion comprises one or more locking members configured to lock the fluid receptacle to the fluid receptacle receiving portion, and wherein the, or each locking member is configured to engage with at least a portion of the fluid receptacle in an interference fit, and wherein the locking members are configured to prevent removal of at least a portion of the fluid receptacle from the fluid receptacle receiving portion.

18. The fluid transfer apparatus of claim 1, wherein the fluid receptacle receiving portion is configured to substantially prevent movement of the fluid receptacle relative to the fluid transfer apparatus when the fluid receptacle is received and engaged by the fluid receptacle receiving portion.

19. The fluid transfer apparatus of claim 1, wherein the fluid receptacle receiving portion is configured to substantially align a longitudinal axis of the fluid receptacle and the longitudinal axis of the fluid transfer apparatus when the fluid receptacle is engaged and received by the fluid receptacle receiving portion.

20. The fluid transfer apparatus of claim 1, wherein, in the first isolation state, the fluid receptacle can be engaged and received by the fluid receptacle receiving portion and the fluid transfer device is configured to be substantially remote from the fluid receptacle when the fluid receptacle is received by the fluid receptacle receiving portion.

21. The fluid transfer apparatus of claim 1, wherein the fluid outlet of the fluid transfer apparatus is configured to be engageable with a fluid inlet of a further fluid transfer apparatus, and wherein the fluid outlet of the fluid transfer apparatus and the fluid inlet of the further fluid transfer apparatus are configured to only be engageable with each other, such that the fluid outlet of the fluid transfer apparatus and the fluid inlet of the further fluid transfer apparatus cannot be engaged with other devices.

22. A fluid transfer system comprising:
a fluid transfer apparatus comprising:
a fluid inlet;
a fluid outlet; and
a fluid transfer device;
wherein the fluid inlet is associated with a fluid receptacle receiving portion, the fluid receptacle receiving portion being configured to receive and engage at least a portion of a fluid receptacle, and wherein, in use, the fluid transfer apparatus is configurable between a first isolation state, in which the fluid transfer device is isolated from the fluid receptacle, such that the fluid container is fluidically isolated from the fluid inlet, to a second coupled state, in which the fluid transfer device is engaged with the fluid receptacle, such that the fluid receptacle is in fluid communication with the fluid inlet; and
a further fluid transfer apparatus, the further fluid transfer apparatus comprising a fluid inlet; and
wherein the fluid outlet of the fluid transfer apparatus is engageable with the fluid inlet of the further fluid transfer apparatus.

23. A kit of parts comprising:
a fluid receptacle; and
a fluid transfer apparatus comprising:
a fluid inlet;
a fluid outlet; and
a fluid transfer device;
wherein the fluid inlet is associated with a fluid receptacle receiving portion, the fluid receptacle receiving portion being configured to receive and engage at least a portion of the fluid receptacle, and wherein, in use, the fluid transfer apparatus is configurable between a first isolation state, in which the fluid transfer device is isolated from the fluid receptacle, such that the fluid container is fluidically isolated from the fluid inlet, to a second coupled state, in which the fluid transfer device is engaged with the fluid receptacle, such that the fluid receptacle is in fluid communication with the fluid inlet.

24-25. (canceled)
